(19) United States
(12) Patent Application Publication
(10) Pub. No.: US 2007/0162662 A1
(43) Pub. Date: Jul. 12, 2007

(54) Methods and apparatuses for dynamically switching network protocols for use in a printing device

(76) Inventors: Brian J. Duggan, Lexington, KY (US); Matthew D. Miles, Lexington, KY (US); Ronald W. Schlentner, Richmond, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/317,576

(22) Filed: Dec. 23, 2005

(51) Int. Cl. G06F 13/38

(52) U.S. Cl. 710/62

(57) ABSTRACT

A single Ethernet network adapter having both 10 Mbps and 100 Mbps networking connections for dual network protocol modes is disclosed in one embodiment. The network adapter converts both 100 Mbps (100BASE-FX) and 10 Mbps (10BASE-FL) network protocols to a single common BASE-TX protocol. The network adapter can receive either of the two network protocol connections over a networking cable and has the ability to operate a printing device from either protocol. The network adapter senses whether 100 or 10 Mbps jacks are connected during operation and dynamically modifies conversion operations based thereon.

### BACKGROUND OF THE INVENTION

The present invention generally relates to network adapter devices and methods for a printer and, in particular, one embodiment relates to a single network adapter for a printer that supports both 100 Mbps and 10 Mbps modes of operation.

A printer network adapter is an electronic option card that can be installed into a printer that has been designed to accept an internal network adapter (INA) card. A printer network adapter may also be an external electronic device or external network adapter (ENA) that is designed to work with a printer. INAs and ENAs allow the printer users to upgrade their printers with extra functions for connecting to a variety of network operating systems over the Ethernet. In the past, printers offered fiber-optic Ethernet connection options of throughputs of either 100 Megabits per second (Mbps) or 10 Mbps. However, printers typically could not offer the option of handling both network transmission speeds and/or of allowing for multiple connection jacks for such speeds over the fiber-optic Ethernet. In other words, the printers did not have a method available that could efficiently support both modes of throughput operation for over a fiber-optic networking cable.

Therefore, there is a need for an improved printer INA or ENA that supports both 100 Mbps and 10 Mbps network connections over cable, such as a fiber optic cable. Further, there is also a need for a printer method and device that can support multiple network connections while minimizing hardware and cost.

### SUMMARY OF THE INVENTION

According to an embodiment of the present invention, a single fiber-optic Ethernet internal network adapter (INA) card supporting both 100 Mbps and 10 Mbps network protocol modes of operation for a printer device is provided. The INA card uses the pins of a 100 Mbps jack to determine which mode of operation is desired and dynamically switches between the two modes of operation without the use of a mechanical switch or use of the power-on-reset (POR) cycle of the printer. The INA card can convert both 100 Mbps and 10 Mbps network protocols to a single common network protocol. The INA card can receive either of the two network protocol connections and has the ability to operate the printer device from either connection.

In accordance with one embodiment of the present invention, a network interface device comprises a plurality of network jacks, where each jack is configured to receive a different communication protocol. The device also includes a sensing circuit configured to detect which jack is connected, and a converter configured with a plurality of conversion programs. Each program is configured to convert the protocol received by a jack to a common protocol. The device further includes a switching circuit configured to select the conversion program of the converter based upon which jack is detected by the sensing circuit as being connected.

In accordance with another embodiment of the present invention, a printer comprises at least one network connector configured to receive a plurality of network communications lines, each communication line operating according to a different communication protocol. The printer further includes a sensing circuit to detect which network communication line is connected, and a converter configured to operate multiple conversion modes, wherein each conversion mode is configured to convert a communication protocol of a communication line to a common protocol. The converter is configured to change which conversion mode is utilized according to which network communication line is detected by the sensing circuit as being connected. The printer further includes a controller to convert the common protocol to a printer signaling protocol.

The network adapters, methods and printers are particular advantageous for providing support for both 100 Mbps (100 BASE-FX) and 10 Mbps (10 BASE-FL) multimode operation to a printer. These and additional advantages will be apparent in viewed of the detailed description.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawings in which the reference number first appears. While the specification concludes with claims particularly pointing out and distinctly claiming the present invention, it is believed the same will be better understood from the following description taken in conjunction with the accompanying drawings in which:

FIG. 1 is a block diagram of an internal network adapter card according to an illustrative embodiment of the present invention;

FIG. 2 is a block diagram of an external network adapter according to another embodiment of the present invention.

The embodiments set forth in the drawings are illustrative in nature and not intended to be limiting of the invention defined by the claims. Moreover, individual features of the drawings and the present invention will be more fully apparent and understood in view of the detailed description.

### DETAILED DESCRIPTION

In the following detailed description of exemplary embodiments, reference is made to the accompanying drawings that form a part hereof, and in which are shown by way of illustration, and not by way of limitation, specific embodiments in which the present invention may be practiced. It is to be understood that other embodiments may be utilized and that logical, mechanical and electrical changes may be made without departing from the spirit and scope of the present invention.

According to one exemplary embodiment, a printer circuit board assembly or circuit board or network adapter for a printer is provided that will support both 100 Mbps (also known as 100 BASE-FX, or fast Ethernet ) and 10 Mbps (also known as 10 BASE-FL or baseband ) multimode operation over a fiber-optic networking cable. The network adapter may be an external network adapter (ENA) or an internal network adapter (INA). The ENA, which is an external device to the printer, performs the same function as the INA card, which is inserted in the printer, described herein. In one exemplary embodiment, the INA card can receive both types of network connections over a fiber-optic Ethernet cable for operation of the printer device. The INA card may have its own processor and memory or may utilize the memory and processing power of the host controller, i.e., the printer. In another exemplary embodiment, the INA card can serve as a fiber-optic printer server which can be used to transfer information from the network connection to a series of different printers. As used herein, printer means a stand-alone printing device or a multifunction device capable of performing at least one other function, such as copying, scanning or faxing, in addition to printing. It will also be appreciated by one of ordinary skill in the art that the network, while described herein as being a fiber-optic network, may be any other suitable type of communication network.

The INA card has the ability to switch operating modes of its controller depending on the type of network cable that is connected to the printer. In one exemplary embodiment, the INA card uses 850 nm optical wavelength for 10 Mbps Ethernet operation and 1300 nm for 100 Mbps Ethernet operation.

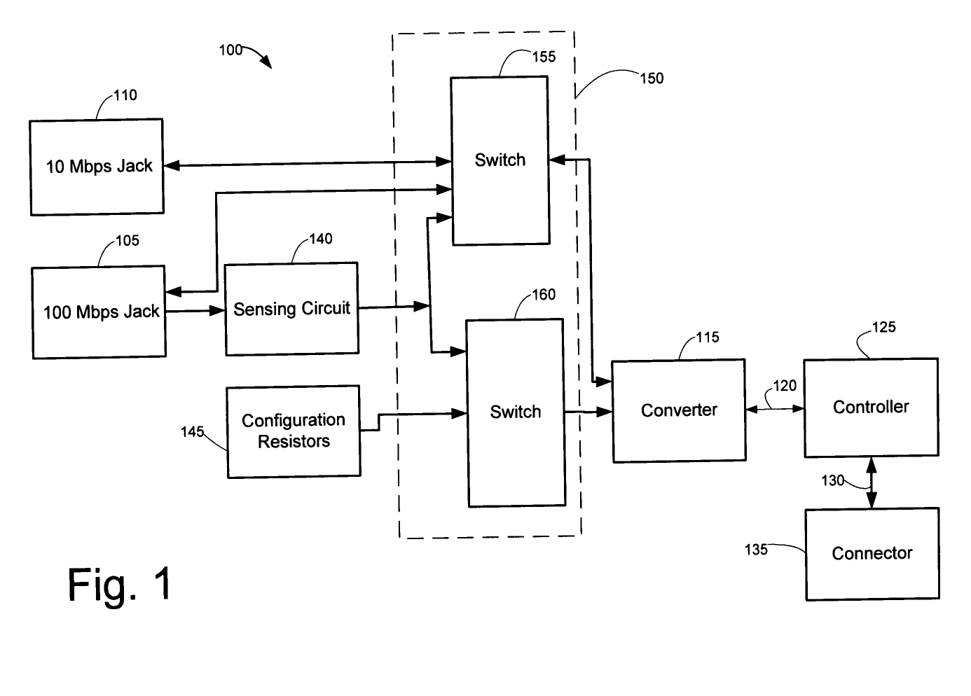

Referring initially to the block diagram of the example internal network adapter (INA) card illustrated in FIG. 1, the INA card 100 includes both a 100 Mbps jack 105 and a 10 Mbps jack 110. 10 Mbps jack may be comprised of two discrete jacks (not shown), which make up the transmit and receiver pair for 10 Mbps operation. The jacks 105, 110 for 100 Mbps and 10 Mbps operation may also be transceivers.

As seen in FIG. 1, a converter 115 can be used to convert the signals coming from the 100 Mbps jack 105 and the 10 Mbps jack 110 into a single common 10/100 BASE-TX signal 120 which then is transmitted to a controller 125. The converter 115 may be, for example, a Micro Linear ML6625CH chip or any other suitable type of converter chip. The controller 125 then converts the 10/100 BASE-TX signaling 120 into a peripheral component interconnect (PCI) bus signal 130 for communication with the host controller of the printer. The controller 125 may be, for example, an Intel 82551 controller or any other suitable type of controller. In an alternate embodiment, the 10/100 BASE-TX signal 120 may be converted into another type of bus signal, such as a universal serial bus signal (USB), as will be understood by one of ordinary skill in the art.

connector 135 can be present on the INA card 100 to interface the PCI signals 130 with the integrated circuits of the printer. The connector 135 can include appropriate connections and/or logic to receive the PCI signals 130 sent from the controller 125 and from the printer electronics along a PCI bus 130, to allow communication between the controller 125 and printer electronics. The connector 135 can be used in conjunction with a programmable logic array (PLA) to synchronize the PCI signals 130 from the controller 125 in order to ensure that the PCI signals 130 used by printer's integrated circuits and the controller 125 communicate properly.

In one embodiment, the connector 135 may be a D-shell connector. In an alternate embodiment, the connector 135 may be an edge connector or any other suitable type of mechanical connection scheme. Accordingly, the INA card 100 can be connected to different printers using a variety of different connectors 135.

A sensing circuit 140 can also be provided to sense the state of the signal detect fiber-optic (SDFO) pin of the 100 Mbps jack 105. The sensing circuit 140 may be comprised of comparators and other simple logic components, as will be understood by one of ordinary skill in the art. The state is used to indicate which jack 105, 110 is plugged in and active. For example, a change in the state of the pin from low to high or from high to low indicates that the network has been plugged in the 100 Mbps jack 105 or unplugged from the 100 Mbps jack 105 When such change is detected, the sensing circuit forces a reset of the converter 115 to occur. The reset may then cause a reading of the configuration resistors 145 to set the operation mode of the converter and ensure that the converter 115 is set up correctly for 100 Mbps or 10 Mbps operation. In one exemplary configuration of the circuit, the power of the printer device is not required to cycle on or off in order for the network protocol operating mode (i.e., 100 Mbps or 10 Mbps) of the INA card 100 to be determined. Instead, during operation, the circuit can dynamically sense which jacks 105, 110 are in use or if the jack 105, 110 in use has been changed. Thus, the networking operation of the printer will be able to automatically adjust accordingly.

As seen in FIG. 1, the INA card 100 can also include a switching circuit 150 for controlling which jack 105, 110 is connected to the converter 115 based on which jack 105, 110 is linked to the network connection. The switching circuit 150 may, in addition, set the proper operation mode of the converter 115 based upon which of the jacks 105, 110 is being used. In the exemplary embodiment shown in FIG. 1, the switching circuit 150 of INA card 100 includes two analog switches 155, 160. The two analog switches 155, 160 contain four channels each. Each channel allows one of two signal lines to be connected to another signal line. The control pin of the switching circuit 150 controls which signal path gets connected to the converter 115. In one embodiment, analog switches 155, 160 in the switching circuit 150 are used to control which set of transmit/receive signals from the jacks 105, 110 get sent to the converter 115.

In one embodiment, the converter 115 may be connected only to either the 100 Mbps jack 105 or the 10 Mbps jack 110 at any one time. In addition, the analog switches 115, 160 of the switching circuit 150 may be used to select the configuration resistors 145 used by the converter 115. The configuration resistors 145 configure the converter 115 since the converter 115 requires a different configuration for 100 Mbps operation than it does for a 10 Mbps operation. Configuration may occur, for example, on the leading or rising edge of the reset signal. In an alternate embodiment, configuration may on the trailing or falling edge of the reset signal. In the exemplary embodiment, the converter 115 samples the inputs of its configuration pins, to check for which operational configuration to utilize.

In one embodiment, additional circuitry components provided may also be to support the INA card 100. In particular, an oscillator or crystal may be used to drive the clocks used by the controller 125 and the converter 115. Additionally, an Electrically Erasable Programmable Read Only Memory (EEPROM) may be used to store manufacturing data on the INA card 100. In an alternate embodiment, other forms of memory, such as flash memory, Read Only Memory (ROM) or Random Access Memory (RAM), may be used to store data or instructions in the INA card 100.

In another exemplary embodiment, a linear DC-to-DC voltage regulator may be used to convert the 5V from the printer to 3.3 volts, the predominant voltage used on the INA card 100. One exemplary embodiment of the present invention includes a reset circuit (not shown). The reset circuit can be used to ensure that the voltages to the converter 115 are stable prior to running the logic inside the converter 115. The converter 115 may also sample the inputs of its configuration pins (again set by the configuration resistors 145) on the rising edge of the reset signal (i.e., PWRDWN), for example.

In one embodiment, the network adapter is an INA card installed in the printer. Integral on the INA card is a network jack, a sensing circuit, a converter and a controller. The network jack on the INA card receives the fiber-optic Ethernet network communication line. The INA card converts the communication signals to a common protocol, such as in a manner as was described above. The controller then interfaces with the printer circuitry through a connector such as described above.

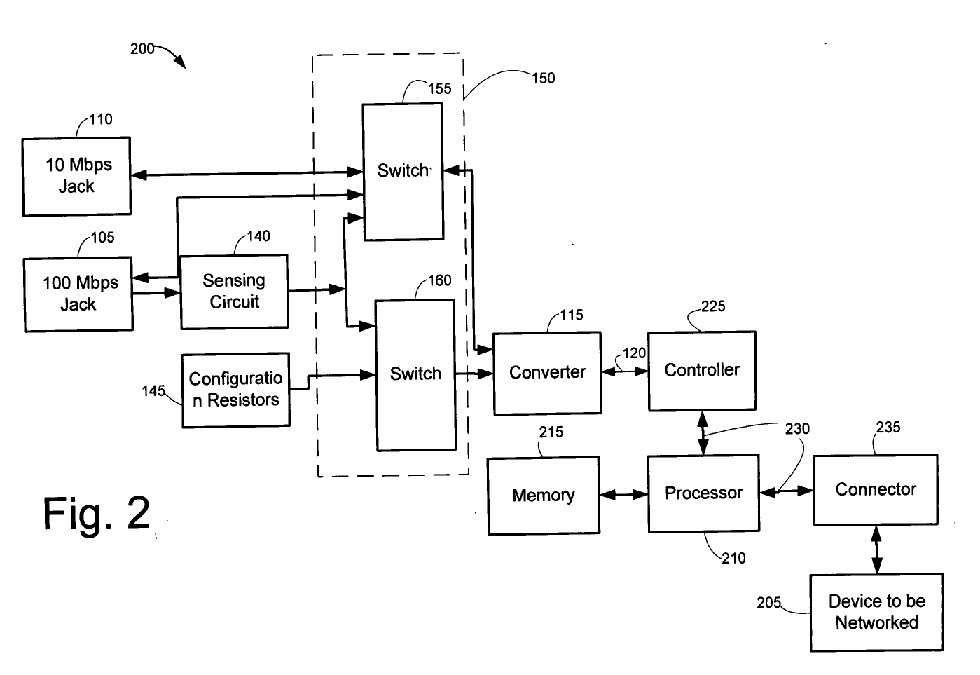

In another embodiment, the circuitry of the INA may be contained in an external network adapter (ENA), such as a printer or network server. An exemplary embodiment of an ENA is shown in FIG. 2. Similar to the INA previously described and shown in FIG. 1, the ENA 200 includes a 100 Mbps jack 105 and a 10 Mbps jack 110.

As seen in FIG. 2, converter 115 can be used to convert the signals coming from the 100 Mbps jack 105 and the 10 Mbps jack 110 into a single common 10/100 BASE-TX signal 120 which then is transmitted to controller 125. The controller 225 converts the 10/100 BASE-TX signaling 120 into a USB signal 230 for communication with the host controller of the printer. In an alternate embodiment, the 10/100 BASE-TX signal 120 may be converted into another type of bus signal, such as a PCI signal, as will be understood by one of ordinary skill in the art.

A connector 235 can be present on the ENA to interface the ENA with a device to be networked 205, such as a printer. The connector 235 can include appropriate connections and/or logic to receive the USB signals 230 sent from the processor 210 along a universal serial bus 230, to allow communication between the processor 205 and the printer 205. The connector 235 can be used in conjunction with a programmable logic array (PLA) to synchronize the USB signals 230 from the controller 125 in order to ensure that the USB signals 230 used by the printer 205 and the ENA 200 communicate properly.

In one embodiment, the connector 235 USB connector. In an alternate embodiment, the connector 235 may an edge connector, a D-shell connector or any other suitable type of mechanical connection scheme. Accordingly, the ENA 200 can be connected to different devices capable of being networked using a variety of different connectors 235.

As described above in connection with FIG. 1, a sensing circuit 140 can also be provided to sense the state of the signal detect fiber-optic (SDFO) pin of the 100 Mbps jack 105 automatically adjust the operation of the network. Similar to the embodiment depicted in FIG. 1, the ENA 200 of FIG. 2 can also include a switching circuit 150 for controlling which jack 105, 110 is connected to the converter and set the proper operation mode of the converter 115 based upon which of the jacks 105, 110 is being used. The converter 115 may be connected only to either the 100 Mbps jack 105 or the 10 Mbps jack 110 at any one time, and the analog switches 115, 160 of the switching circuit 150 may be used to select the configuration resistors 145 used by the converter 115.

As shown in FIG. 2, additional circuitry components provided may be provided to support the ENA 200. In particular, an oscillator or crystal may be used to drive the clocks used by the controller 125 and the converter 115. Additionally, memory 215, such as an Electrically Erasable Programmable Read Only Memory (EEPROM), flash memory, Read Only Memory (ROM) or Random Access Memory (RAM), may be used to store data or instructions in the ENA 200. In another exemplary embodiment, a linear DC-to-DC voltage regulator may be used to convert the 5V from the printer to 3.3 volts, the predominant voltage used on ENA 200. ENA 200 may also include a reset circuit (not shown) to ensure that the voltages to the converter 115 are stable prior to running the logic inside the converter 115. The converter 115 may also sample the inputs of its configuration pins (again set by the configuration resistors 145) on the rising edge of the reset signal (i.e., PWRDWN), for example.

Accordingly, the embodiments described herein can be incorporated as removable or integrated hardware in network devices, such as computers, printers and related devices.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

Having described the invention in detail and by reference to specific exemplary embodiments thereof, it will be apparent that modifications and variations are possible without departing from the scope of the invention defined in the appended claims. For example, some principles of the inventions may be used with different types of printers, printing devices, and circuit elements, as well as with different communication and signaling protocols. Moreover, although multiple inventive aspects and principles have been presented, such aspects these need not be utilized in combination, and various combinations of inventive aspects and principles are possible in light of the various embodiments provided above. In addition, although some aspects of the present invention are identified herein as particularly advantageous, it is contemplated that the present invention is not necessarily limited to these advantageous aspects of the invention.

What is claimed is:

1. A network interface device, comprising:
a plurality of network jacks, wherein each jack is configured to receive a different communication protocol;
a sensing circuit to detect which jack is configured;
a converter configured with a plurality of conversion configurations, wherein each configuration is configured to convert the protocol received by a jack to a common protocol; and
a switching circuit configured to select the conversion program of the converter based upon which jack is detected by the sensing circuit as being connected.

2. The network interface device recited in claim 1, further comprising a controller to convert the common protocol to a printer signaling protocol.

3. The network interface device recited in claim 2, further comprising a programmable logic array configured to make corrections to the printer signaling protocol.

4. The network interface device recited in claim 2, further comprising a connector for receiving the printer signaling protocol and communicating the printer signaling protocol to a printer.

5. The network interface device recited in claim 4, wherein the connector comprises at least one from the group consisting of a D-shell connector and an edge connector.

6. The network interface device as recited in claim 1, wherein the sensing circuit is configured to sense the state of a signal detect pin of the connected jack.

7. The network interface device as recited in claim 6, wherein the device is configured such that a change of state of the signal detect pin of the connected jack forces a reset of the single converter.

8. The network interface device as recited in claim 1, wherein the switching circuit is further configured to connect one of the jacks to the converter based upon which jack is detected by the sensing circuit as being connected.

9. The network interface device as recited in claim 1, wherein the switching circuit is further configured to select the conversion program through the use of configuration resistors.

10. The network interface device as recited in claim 1, wherein the different communication protocols comprise 10 BASE-FL and 100 BASE-FX.

11. The network interface device as recited in claim 1, wherein the different communication protocols comprise 10 Mbps and 100 Mbps.

12. The network interface device as recited in claim 1, wherein the network jacks comprise a pair of two discrete transmit and receive jacks for 10 Mbps and a single jack for 100 Mbps.

13. The network interface device as recited in claim 1, wherein the common protocol is 10/100 BASE-TX.

14. A printer, comprising:
at least one network connector configured to receive a plurality of network communications lines, each communication line operating according to a different communication protocol;
a sensing circuit to detect which network communication line is connected;
a converter configured to operate multiple conversion modes, wherein each conversion mode is configured to convert a communication protocol of a communication line to a common protocol, and wherein the converter is configured to change which conversion mode is utilized according to which network communication line is detected by the sensing circuit as being connect; and
a controller to convert the common protocol to a printer signaling protocol.

15. The printer as recited in claim 14, wherein the communication lines comprise fiber optic communications lines.

16. The printer as recited in claim 14, wherein the sensing circuit, converter, and controller are integral.

17. The printer as recited in claim 14, wherein the different communication protocols comprise a 10 BASE-FL protocol and a 100 BASE-FX protocol, wherein the common protocol comprises 10/100 BASE-TX protocol, and wherein the printer signaling protocol comprises a PCI protocol.

18. A method for communicating between multiple network protocols and a printer, comprising:
receiving a first network communication protocol over a first jack on a printer;
receiving a second network communication protocol over a second jack on a printer;
converting the first and second protocols to a common protocol for use in the printer by using an integrated circuit; and
using the common protocol to control functions of the printer.

19. The method as recited in claim 18, further comprising switching modes of operation of the integrated circuit based upon which of the two jacks is sensed as connected to a network communication cable.

20. The method as recited in claim 18, further comprising sensing which of the jacks are connected, wherein said switching circuit connections are based upon said sensing.
